(19) United States
(12) Patent Application Publication
(10) Pub. No.: US 2025/0027175 A1
(43) Pub. Date: Jan. 23, 2025

(54) SUGAR CANE SHRED PRESS ROLLER AND PRESSER COMPRISING SAME

(71) Applicant: Shaanxi University of Science and Technology, Xi'an (CN)

(72) Inventors: Haifeng Chen, Xi'an (CN); Yanlong Hu, Xi'an (CN); Shaobo Dong, Xi'an (CN); Bo Wang, Xi'an (CN); Yao Niu, Xi'an (CN); Yueying Yang, Xi'an (CN)

(73) Assignee: Shaanxi University of Science and Technology, Xi'an (CN)

(21) Appl. No.: 18/772,728

(22) Filed: Jul. 15, 2024

(30) Foreign Application Priority Data
Jul. 20, 2023 (CN) 202310895319.4

(51) Int. Cl. C13B 10/06; C13B 5/04

(52) U.S. Cl. CPC C13B 10/06; C13B 5/04

(57) ABSTRACT

A sugar cane shred press roller and a presser including the same are provided, which belong to the technical field of sugar-making equipment. Several circumferential bosses are arranged in an axial direction of a cylindrical roller body of the sugar cane shred press roller; modified cylindrical helical gears with opposite modification coefficients are formed on both sides of each of the circumferential bosses; and an annular juice discharge groove is formed between adjacent circumferential bosses. A presser with the sugar cane shred press roller is provided, axes of several sugar cane shred press rollers are spatially parallel with each other, the circumferential bosses and the juice discharge grooves of the adjacent sugar cane shred press rollers fit with each other and have gaps left, and the modified cylindrical helical gears of the adjacent sugar cane shred press rollers are meshed with each other.

### CROSS-REFERENCE TO RELATED APPLICATION

This patent application claims the benefit and priority of Chinese Patent Application No. 202310895319.4 filed with the China National Intellectual Property Administration on Jul. 20, 2023, the disclosure of which is incorporated by reference herein in its entirety as part of the present application.

### TECHNICAL FIELD

The present disclosure relates to the technical field of sugar-making equipment, and in particular to a sugar cane shred press roller and a presser comprising the same.

### BACKGROUND

The production process of sugar cane juice extraction by pressing is a technological process of extracting sugar cane juice by cutting sugar cane into small segments and shredding, and then repeatedly pressing by a presser and soaking. A roller shell of the traditional presser roller is of a hollow structure.

During sugar cane shred pressing, multiple V-shaped tooth grooves fitting with each other are arranged on the surfaces of a pair of rollers. The grooved roller surfaces can improve the holding capacity of sugar cane shred during pressing, have the functions of crushing and shredding the sugar cane materials, are beneficial to juice drainage, and can increase the contact area between the roller surfaces during pressing. However, this traditional method has limited improvement in sugar cane shred holding capacity, pressing and shredding, and the degree of improvement in pressing area is still not high, which may easily lead to problems such as blockage during pressing.

In addition, cemented carbide spots are randomly welded on the side surface of a V-shaped tooth pattern, and the spots on the side surface of the V-shaped tooth pattern of the roller surface are meshed with gaps between spots on another paired roller surface, thereby further improving the sugar cane shred holding capacity and enhancing the functions of crushing and shredding. However, during the pressing of sugar cane material, some spots cannot mesh smoothly, but directly compress or interfere with each other, so that the pressure here is high, but the pressure on the sugar cane material located in the gap around the spots is small. Obviously, in this method results in the force on the sugar cane material uneven during pressing, the juice extraction of sugar cane material insufficient, and the fatigue damage and detachment of cemented carbide gold spots, the shortening of the life of the roller shell. Moreover, this method leads to the increase of the processing cost of the roller, and is time-consuming and laborious in the welding of cemented carbide spots.

### SUMMARY

In order to solve the defects in the prior art, an objective of the present disclosure is to provide a sugar cane shred press roller and a presser comprising the same. The sugar cane shred press roller is reasonable in structure and design, and thus the sugar cane shred holding, crushing and shredding capabilities of the roller can be significantly improved, the contact area and force uniformity during pressing can be improved, and the probability of blockage can be reduced. The present disclosure provides the following technical solution:

A sugar cane shred press roller comprising: a cylindrical roller body; several circumferential bosses arranged in an axial direction of the cylindrical roller body; modified cylindrical helical gears with opposite modification coefficients formed on both sides of each of the circumferential bosses; and annular juice discharge grooves, each annular juice discharge groove is formed between every two adjacent circumferential bosses.

Preferably, each of the modified cylindrical helical gears takes a middle surface of a tooth width as a reference point. One side of the middle surface is positively modified to a positively modified tooth profile end, with the modification coefficient increasing gradually, while another side of the middle surface is negatively modified to a negatively modified tooth profile end, with the modification coefficient increasing gradually.

Further, preferably, the modification coefficient changes uniformly and linearly, and the modification coefficient ranges from −1.5 to +1.5.

Preferably, a diameter of each of the circumferential bosses is equal to a diameter of a big end of each of the modified cylindrical helical gears.

Preferably, the tooth width of each of the modified cylindrical helical gears is not greater than 100 mm, and a width of the juice discharge groove is less than 30 mm.

Preferably, the circumferential bosses and the juice discharge groove fit with each other in shape.

Preferably, the several circumferential bosses are uniformly distributed at equal intervals.

Preferably, the roller body, the modified cylindrical helical gears, and the circumferential bosses are integrally formed.

Preferably, the modified cylindrical helical gears each have a modulus of 3-8 mm.

A presser is provided, including several sugar cane shred press rollers above. Axes of the several sugar cane shred press rollers are spatially parallel with each other, the circumferential bosses and the juice discharge grooves of the adjacent sugar cane shred press rollers fit with each other and have gaps left, and the modified cylindrical helical gears of the adjacent sugar cane shred press rollers are meshed with each other.

Compared with the prior art, the present disclosure achieves the following beneficial effects:

According to the sugar cane shred press roller provided in the present disclosure, the force-bearing problem during pressing can be effectively improved by taking advantages of the mesh of helical gears. During pressing, the sugar cane shred holding and crushing capabilities of the roller shell are significantly improved through the meshing between the teeth on the roller surface. Further, the meshing process of the helical gears is stable, which improves the uniformity of a pressing force distribution and ensures a good juice yield. An additional axial force produced in the meshing process further shreds the sugar cane material. By constructing a modified helical gear tooth pattern on the side surface of a traditional “V”-shaped tooth groove in the axial direction, the contact length in a circumferential direction of the roller is significantly increased, the pressing area can be greatly increased, and the juice extraction efficiency of sugar cane shred by pressing can be improved.

Further, each of the modified cylindrical helical gears takes the middle surface of the tooth width as the reference point. One side of the middle surface is positively modified to a positively modified tooth profile end, with the modification coefficient increasing gradually, while another side of the middle surface is negatively modified to a negatively modified tooth profile end, with the modification coefficient increasing gradually. Through such a structure, an annular V-shaped juice discharge groove is formed between the modified cylindrical helical gear on one circumferential boss and the modified cylindrical helical gear on another circumferential boss.

Still further, the modification coefficient changes uniformly and linearly, and the modification coefficient ranges from −1.5 to +1.5. If the modification coefficient is too small, the thickness of a tooth root at a negatively modified end of the modified gear is too small, leading to the decrease of the strength and the load capacity. If the modification coefficient is too large, the meshing process is unstable, resulting in jamming, and thus the pressing is affected.

Further, the diameter of each of the circumferential bosses is equal to the diameter of the big end of each of the modified cylindrical helical gears, thus facilitating the meshing of two gears.

Further, a tooth width of each of the modified cylindrical helical gears is not greater than 100 mm, and a width of the juice discharge groove is less than 30 mm. If the tooth surface is too wide, there is a significant difference between the big end and a small end, which is adverse to the gear forming and juice discharge. For short, the tooth is not steep enough, and the juice discharge is unsmooth.

Further, the circumferential bosses and the juice discharge groove fit with each other in shape. By arranging multiple press rollers, the circumferential bosses and the juice discharge grooves of the adjacent press rollers are located at proper working positions, so as to improve the pressing effect.

Further, the several circumferential bosses are uniformly distributed at equal intervals, so that the force is uniformly throughout the sugar cane shred.

Further, the roller body, the modified cylindrical helical gears, and the circumferential bosses are integrally formed, and thus the manufacturing and processing are simple and convenient, the overall strength is high, and the service life is long.

According to the presser comprising the sugar cane shred press roller provided in the present disclosure, by arranging the multiple sugar cane shred press rollers in parallel in space, the modified cylindrical helical gears on the adjacent sugar cane shred press rollers can be meshed with each other to remarkably improve the sugar cane shred holding, crushing and shredding abilities of the roller and increase the pressing contact area and improve the uniformity of force. The circumferential bosses and the juice discharge grooves of the adjacent sugar cane shred press rollers are in fit with each other and have gaps left, such that the bagasse and the juice can be discharged in time, and the probability of blockage is reduced.

### BRIEF DESCRIPTION OF THE DRAWINGS

FIG. 1 is a schematic diagram of an overall structure of a sugar cane shred press roller according to the present disclosure;

FIG. 2 is a sectional view of a front internal structure of a sugar cane shred press roller according to the present disclosure;

FIG. 3 is a partial enlarged view of FIG. 2;

FIG. 4 is a sectional view of A-A in FIG. 2;

FIG. 5 is a partial enlarged view of FIG. 4;

FIG. 6 is a schematic diagram of a three-dimensional structure of a sugar cane shred press roller according to the present disclosure;

FIG. 7 is a schematic diagram of a partial three-dimensional structure of a presser according to the present disclosure.

In the drawings: 1—modified cylindrical helical gear; 2—juice discharge groove; 3—circumferential boss; 101—positively modified tooth profile end; 102—middle surface; 103—negatively modified tooth profile end.

### DETAILED DESCRIPTION OF THE EMBODIMENTS

The present disclosure is further described in detail below with reference to the accompanying drawings and specific embodiments, and the content of description is used to explain than limiting the present disclosure.

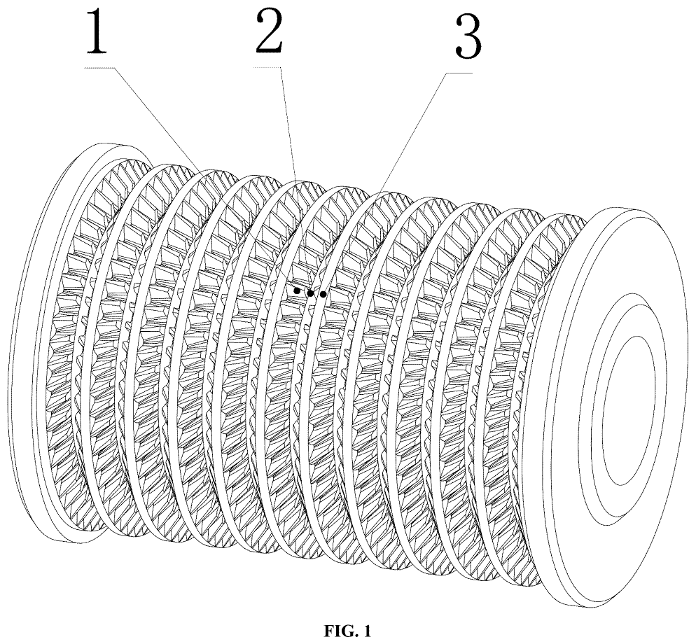

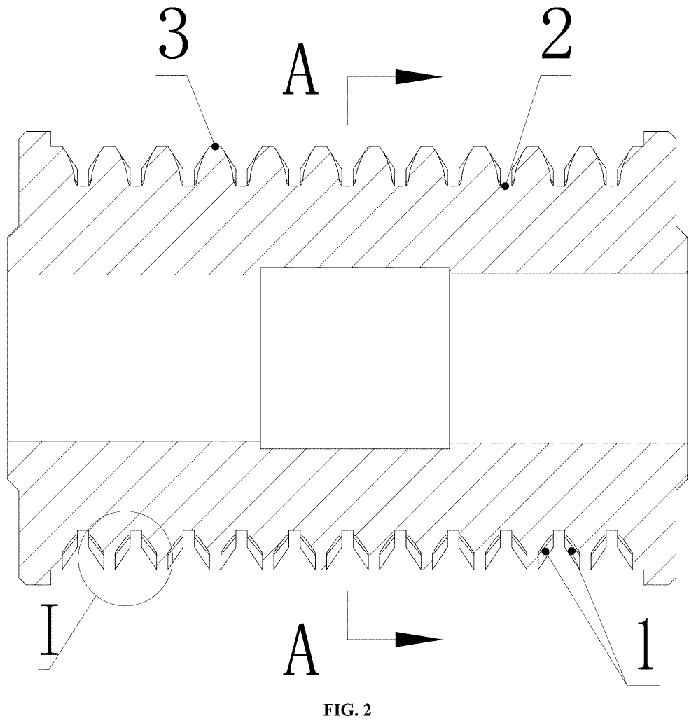

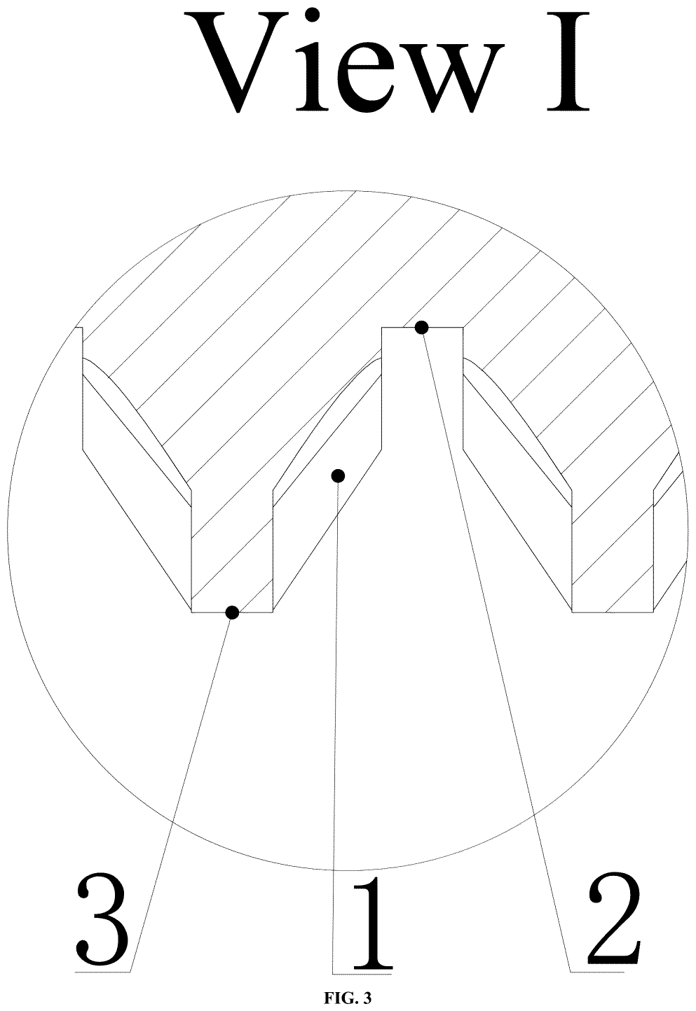

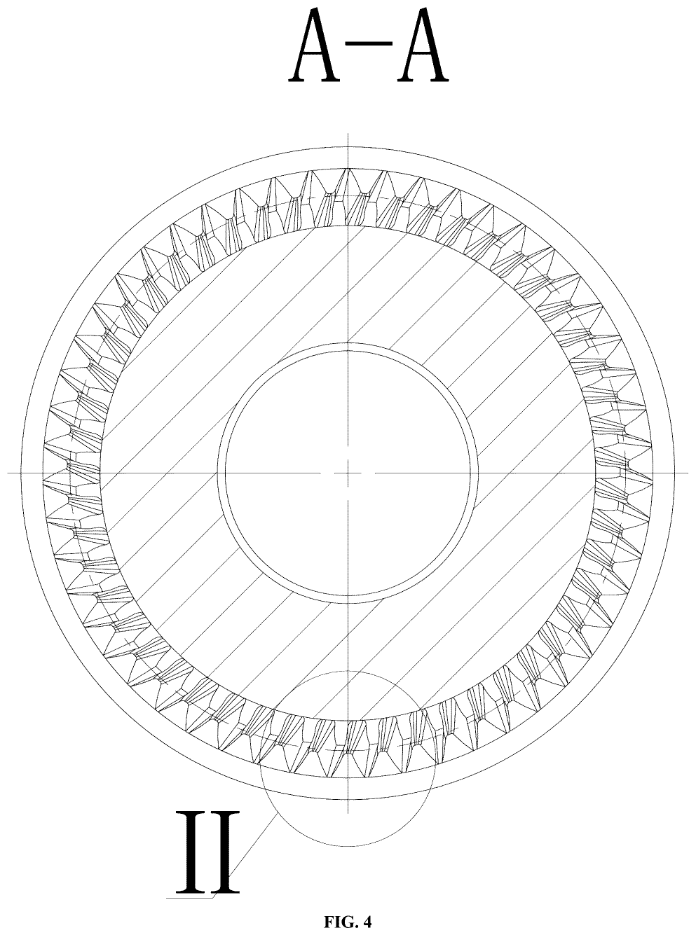

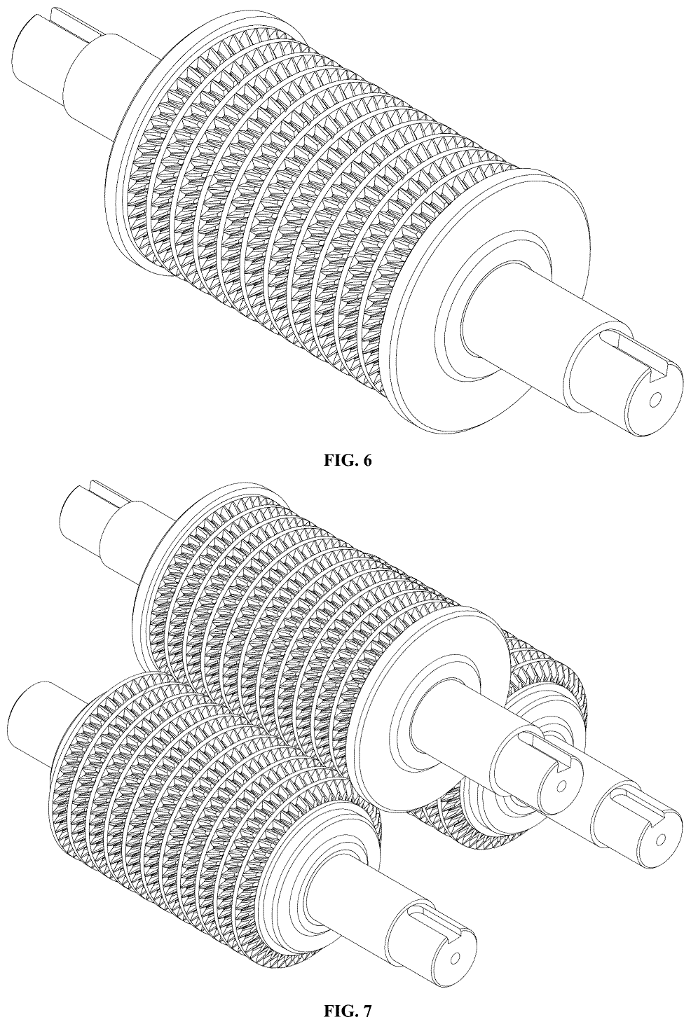

As shown in FIG. 1 to FIG. 4 and FIG. 6, a sugar cane shred press roller includes a cylindrical roller body; and several circumferential bosses 3 arranged in an axial direction of the roller body; modified cylindrical helical gears 1 with opposite modification coefficients formed on both sides of each of the circumferential bosses 3; and annular juice discharge grooves 2, each annular juice discharge groove is formed between every two adjacent circumferential bosses 3.

Opposite modification coefficients refer to that one of the modification coefficients is positive, and another is negative, which are equal in value. In general, when the modification coefficient is positive, it is called positive modification, and the when the modification coefficient is negative, it is called negative modification.

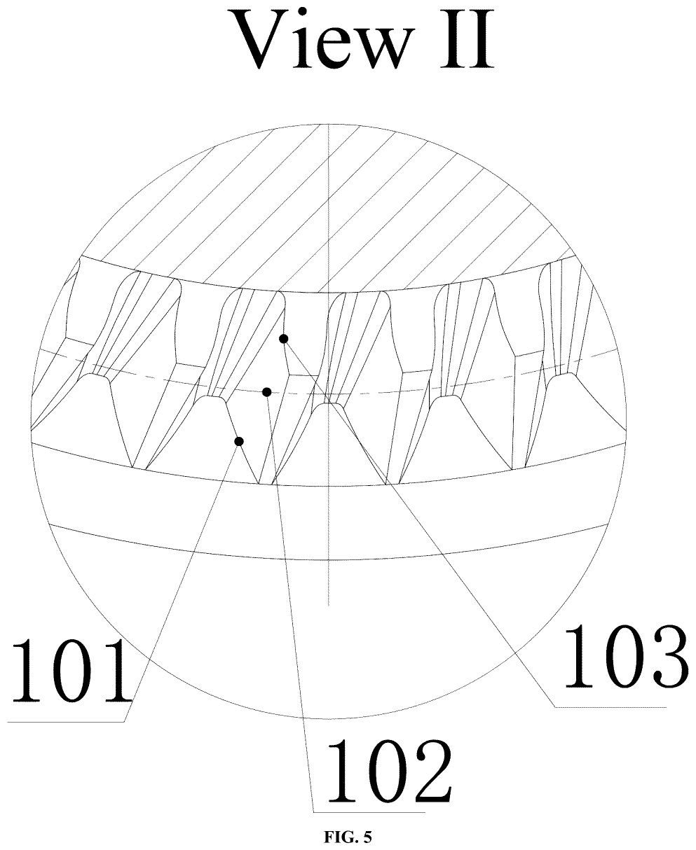

As shown in FIG. 5, in a preferred embodiment of the present disclosure, each of the modified cylindrical helical gears 1 takes a middle surface 102 of a tooth width as a reference point, and one side of the middle surface 102 is positively modified to a positively modified tooth profile end 101, with the modification coefficient increasing gradually, while another side of the middle surface 102 is negatively modified to a negatively modified tooth profile end 103, with the modification coefficient increasing gradually. Preferably, the modification coefficient changes uniformly and linearly, and the modification coefficient ranges from −1.5 to +1.5.

In a preferred embodiment of the present disclosure, a diameter of each of the circumferential bosses 3 is equal to a diameter of a big end of each of the modified cylindrical helical gears 1.

In a preferred embodiment of the present disclosure, the tooth width of each of the modified cylindrical helical gears 1 is not greater than 100 mm, and a width of the juice discharge groove 2 is less than 30 mm.

In a preferred embodiment of the present disclosure, the circumferential bosses 3 and the juice discharge groove 2 fit with each other in shape. A shape of an end of the circumferential boss 3 may have a certain width, may be relatively sharp, and may have equal angle on both sides.

In a preferred embodiment of the present disclosure, the several circumferential bosses 3 are uniformly distributed at equal intervals.

In a preferred embodiment of the present disclosure, the roller body, the modified cylindrical helical gears 1, and the circumferential bosses 3 are integrally formed. In actual production, the juice discharge grooves 2 may be processed through an integrated casting process, by forming the circumferential bosses 3, as well as the modified cylindrical helical gears 1 on both sides of each of the circumferential bosses 3.

In a preferred embodiment, the modified cylindrical helical gears 1 each have a modulus of 3-8 mm.

According to a presser comprising the sugar cane shred press roller provided in the present disclosure, the axes of the several sugar cane shred press rollers are spatially parallel with each other, the circumferential bosses 3 and the juice discharge grooves 2 of the adjacent sugar cane shred press rollers fit with each other and have gaps left, and the modified cylindrical helical gears 1 of the adjacent sugar cane shred press rollers are meshed with each other.

The axes of the several sugar cane shred press rollers are spatially parallel with each other in. Specifically, the several sugar cane shred press rollers can be arranged in a straight line, or three-dimensionally arranged in a triangular shape. As shown in FIG. 7, certainly, other spatial arrangements are also possible, which are specifically designed according to the structure of the presser.

When the sugar cane shred presser including the sugar cane shred press rollers arranged in a triangular shape works:

As shown in FIG. 7, a sugar cane material is fed between a top roller and a front roller for primary pressing, and is fed between the top roller and a rear roller for the second pressing after the primary pressing, and the three-roller sugar cane shred presser can continuously press the sugar cane material for twice.

The above is only part of the embodiment of the present disclosure. Although some terms are used in the present disclosure, the possibility of using other terms is not excluded. These terms are merely used for describing and explaining the essence of the present disclosure more conveniently, and to construe these terms as any additional limitations is against the spirit of the present disclosure. The above descriptions of embodiments are provided for further illustrating the content of the present disclosure, so as to facilitate understanding, rather than representing that the present disclosure is limited to the disclosed embodiments. Any technique extension and recreation according to the present disclosure should be included within the scope of protection of the present disclosure.

1. A sugar cane shred press roller, comprising:
a cylindrical roller body, wherein several circumferential bosses are arranged in an axial direction of the cylindrical roller body;
modified cylindrical helical gears with opposite modification coefficients formed on both sides of each of the circumferential bosses; and
annular juice discharge grooves, each of the annular juice discharge grooves is formed between every two adjacent circumferential bosses of the several circumferential bosses.

2. The sugar cane shred press roller according to claim 1, wherein each of the modified cylindrical helical gears takes a middle surface of a tooth width as a reference point, and one side of the middle surface is positively modified to a positively modified tooth profile end, with the modification coefficient increasing gradually, while another side of the middle surface is negatively modified to a negatively modified tooth profile end, with the modification coefficient increasing gradually.

3. The sugar cane shred press roller according to claim 2, wherein the modification coefficient changes uniformly and linearly, and the modification coefficient ranges from −1.5 to +1.5.

4. The sugar cane shred press roller according to claim 1, wherein a diameter of each of the circumferential bosses is equal to a diameter of a big end of each of the modified cylindrical helical gears.

5. The sugar cane shred press roller according to claim 1, wherein the tooth width of each of the modified cylindrical helical gears is not greater than 100 mm, and a width of the juice discharge groove is less than 30 mm.

6. The sugar cane shred press roller according to claim 1, wherein the circumferential bosses and the juice discharge groove fit with each other in shape.

7. The sugar cane shred press roller according to claim 1, wherein the several circumferential bosses are uniformly distributed at equal intervals.

8. The sugar cane shred press roller according to claim 1, wherein the roller body, the modified cylindrical helical gears, and the circumferential bosses are integrally formed.

9. The sugar cane shred press roller according to claim 1, wherein the modified cylindrical helical gears have a modulus of 3-8 mm.

10. A presser, comprising several sugar cane shred press rollers according to claim 1, wherein axes of the several sugar cane shred press rollers are spatially parallel with each other, the circumferential bosses and the juice discharge grooves of the adjacent sugar cane shred press rollers fit with each other and have gaps left, and the modified cylindrical helical gears of the adjacent sugar cane shred press rollers are meshed with each other.

11. A presser, comprising several sugar cane shred press rollers according to claim 2, wherein axes of the several sugar cane shred press rollers are spatially parallel with each other, the circumferential bosses and the juice discharge grooves of the adjacent sugar cane shred press rollers fit with each other and have gaps left, and the modified cylindrical helical gears of the adjacent sugar cane shred press rollers are meshed with each other.

12. A presser, comprising several sugar cane shred press rollers according to claim 3, wherein axes of the several sugar cane shred press rollers are spatially parallel with each other, the circumferential bosses and the juice discharge grooves of the adjacent sugar cane shred press rollers fit with each other and have gaps left, and the modified cylindrical helical gears of the adjacent sugar cane shred press rollers are meshed with each other.

13. A presser, comprising several sugar cane shred press rollers according to claim 4, wherein axes of the several sugar cane shred press rollers are spatially parallel with each other, the circumferential bosses and the juice discharge grooves of the adjacent sugar cane shred press rollers fit with each other and have gaps left, and the modified cylindrical helical gears of the adjacent sugar cane shred press rollers are meshed with each other.

14. A presser, comprising several sugar cane shred press rollers according to claim 5, wherein axes of the several sugar cane shred press rollers are spatially parallel with each other, the circumferential bosses and the juice discharge grooves of the adjacent sugar cane shred press rollers fit with each other and have gaps left, and the modified cylindrical helical gears of the adjacent sugar cane shred press rollers are meshed with each other.

15. A presser, comprising several sugar cane shred press rollers according to claim 6, wherein axes of the several sugar cane shred press rollers are spatially parallel with each other, the circumferential bosses and the juice discharge grooves of the adjacent sugar cane shred press rollers fit with each other and have gaps left, and the modified cylindrical helical gears of the adjacent sugar cane shred press rollers are meshed with each other.

16. A presser, comprising several sugar cane shred press rollers according to claim 7, wherein axes of the several sugar cane shred press rollers are spatially parallel with each other, the circumferential bosses and the juice discharge grooves of the adjacent sugar cane shred press rollers fit with each other and have gaps left, and the modified cylindrical helical gears of the adjacent sugar cane shred press rollers are meshed with each other.

17. A presser, comprising several sugar cane shred press rollers according to claim 8, wherein axes of the several sugar cane shred press rollers are spatially parallel with each other, the circumferential bosses and the juice discharge grooves of the adjacent sugar cane shred press rollers fit with each other and have gaps left, and the modified cylindrical helical gears of the adjacent sugar cane shred press rollers are meshed with each other.

18. A presser, comprising several sugar cane shred press rollers according to claim 9, wherein axes of the several sugar cane shred press rollers are spatially parallel with each other, the circumferential bosses and the juice discharge grooves of the adjacent sugar cane shred press rollers fit with each other and have gaps left, and the modified cylindrical helical gears of the adjacent sugar cane shred press rollers are meshed with each other.
